(19) United States
(12) Patent Application Publication
(10) Pub. No.: US 2019/0080065 A1
(43) Pub. Date: Mar. 14, 2019

(54) DYNAMIC INTERFACE FOR CAMERA-BASED AUTHENTICATION

(71) Applicant: Synaptics Incorporated, San Jose, CA (US)

(72) Inventor: Mohamed Ashraf Sheik-Nainar, San Jose, CA (US)

(21) Appl. No.: 15/702,481

(22) Filed: Sep. 12, 2017

(51) Int. Cl. G06F 21/32; G06K 9/00

(52) U.S. Cl. CPC G06F 21/32; G06K 9/00281; G06K 9/00912; G06K 9/00255; G06K 9/00899; G06K 9/00288

(57) ABSTRACT

A dynamic interface for camera-based authentication. An input device captures an image of a user during an instance of camera-based authentication. The input device selects a positioning template from a plurality of positioning templates based at least in part on a security level associated with the instance of camera-based authentication. The image of the user is displayed, concurrently with the selected positioning template, in a visual interface. The input device captures an authentication image when one or more features of the user relative are aligned with one or more visual cues of the first positioning template.

### TECHNICAL FIELD

The present embodiments relate generally to authentication, and specifically to a dynamic interface for camera-based authentication.

### BACKGROUND OF RELATED ART

Authentication is a mechanism for verifying the identity of a user (e.g., an individual or entity) attempting to access a device and/or application. A basic form of authentication may require a user to input a username and password via an input device. However, usernames and passwords are easily stolen and can be used by anyone (e.g., not just the authorized user) to gain access to a corresponding device or application. Thus, modern authentication schemes increasingly rely on biometric sensors (e.g., capable of identifying unique biological characteristics of the user) to provide greater levels of security. Example biometric sensors include: fingerprint scanners, facial recognition systems, eye scanners, voice recognition systems, and the like. Biometric inputs typically require the user to physically interact with one or more sensors to perform authentication.

Although more secure, biometric authentication schemes are not without their limitations. For example, a rudimentary camera-based facial recognition system may be spoofed by a photo of the authorized user (e.g., in lieu of the actual user's face). More advanced facial recognition systems may provide greater security by collecting more data points about the user's face. For example, a relatively advanced facial recognition system may require the user's face to be positioned in specific angles, poses, and/or distances from the camera. Specifically, more secure facial recognition schemes tend to require more user interaction (e.g., to ensure that the individual operating the camera is in fact the authorized user). This results in a trade-off between security and convenience to the user.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A dynamic interface for camera-based authentication is disclosed. An input device captures a first image of a user during a first instance of camera-based authentication. The input device selects a first positioning template from a plurality of positioning templates based at least in part on a security level associated with the first instance of camera-based authentication. The first image of the user is displayed, concurrently with the first positioning template, in a visual interface. For example, each of the positioning templates may be configured to be presented as a graphic overlay in the visual interface. The input device captures an authentication image when one or more features of the user are aligned with one or more visual cues of the first positioning template.

In some aspects, the input device may compare the authentication image with stored authentication data. For example, the input device may authenticate the user based on whether the authentication image matches the stored authentication data. In some implementations, the one or more visual cues of the first positioning templates may be generated based at least in part on the stored authentication data.

The input device may further capture a second image of the user during a second instance of camera-based authentication. The input device may further select a second positioning template from the plurality of positioning templates based at least in part on a security level associated with the second instance of camera-based authentication. The security level associated with the second instance may be lower than the security level associated with the first instance. The input device may display the second image of the user concurrently with the second positioning template in the visual interface.

In some aspects, the second instance of the camera-based authentication may be part of a multi-modal authentication attempt. For example, the multi-modal authentication attempt may include a greater number of authentication modes than an authentication attempt associated with the first instance of camera-based authentication. In other aspects, the second instance of the camera-based authentication may be part of a multi-factor authentication attempt. For example, the multi-factor authentication attempt may include a greater number of authentication factors than an authentication attempt associated with the first instance of camera-based authentication.

In some aspects, the first positioning template may include more visual cues than the second positioning template. In some other aspects, the first positioning template may correspond with closer image capture distances than the second positioning templates.

Still further, in some aspects, the input device may capture a third image of the user during a third instance of camera-based authentication. For example, a security level associated with the third instance of camera-based authentication may be lower than the security level associated with the first instance. The input device may further display the third image of the user, without any of the positioning templates, in the visual interface.

### BRIEF DESCRIPTION OF THE DRAWINGS

The present embodiments are illustrated by way of example and are not intended to be limited by the figures of the accompanying drawings.

FIG. 1 shows an example input device within which the present embodiments may be implemented.

FIG. 2 is a block diagram of an input device capable of generating a dynamic interface for camera-based authentication, in accordance with some embodiments.

FIGS. 3A and 3B show example visual interfaces depicting a positioning template that may be used in camera-based authentication schemes with relaxed security requirements.

FIGS. 4A and 4B show example visual interfaces depicting a positioning template that may be used in camera-based authentication schemes with relatively relaxed security requirements.

FIGS. 5A and 5B show example visual interfaces depicting a positioning template that may be used in camera-based authentication schemes with relatively strict security requirements.

FIGS. 6A and 6B show example visual interfaces depicting a positioning template that may be used in camera-based authentication schemes with strict security requirements.

FIG. 7 is a block diagram of an input device capable of generating a dynamic interface for camera-based authentication, in accordance with some other embodiments.

FIG. 8 is an illustrative flowchart depicting an example operation for dynamically generating an interface for camera-based authentication.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. The interconnection between circuit elements or software blocks may be shown as buses or as single signal lines. Each of the buses may alternatively be a single signal line, and each of the single signal lines may alternatively be buses, and a single line or bus may represent any one or more of a myriad of physical or logical mechanisms for communication between components.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory computer-readable storage medium comprising instructions that, when executed, performs one or more of the methods described above. The non-transitory computer-readable storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors. The term “processor,” as used herein may refer to any general purpose processor, conventional processor, controller, microcontroller, and/or state machine capable of executing scripts or instructions of one or more software programs stored in memory.

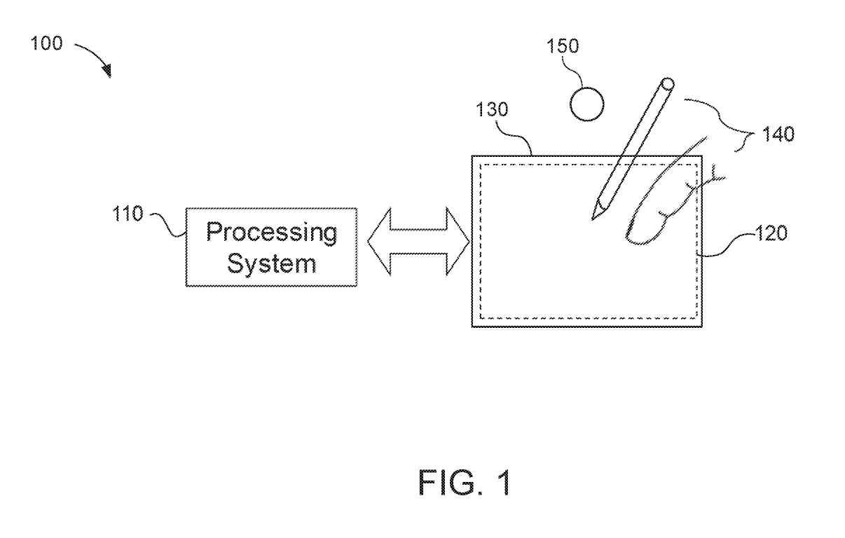

FIG. 1 shows an example input device 100 within which the present embodiments may be implemented. The input device 100 includes a processing system 110, a sensing region 120, and a display 130. The input device 100 may be configured to provide input to an electronic system (not shown for simplicity). Examples of electronic systems may include personal computing devices (e.g., desktop computers, laptop computers, netbook computers, tablets, web browsers, e-book readers, and personal digital assistants (PDAs)), composite input devices (e.g., physical keyboards, joysticks, and key switches), data input devices (e.g., remote controls and mice), data output devices (e.g., display screens and printers), remote terminals, kiosks, video game machines (e.g., video game consoles, portable gaming devices, and the like), communication devices (e.g., cellular phones such as smart phones), and media devices (e.g., recorders, editors, and players such as televisions, set-top boxes, music players, digital photo frames, and digital cameras).

In some aspects, the input device 100 may be implemented as a physical part of the corresponding electronic system. Alternatively, the input device 100 may be physically separated from the electronic system. The input device 100 may be coupled to (and communicate with) components of the electronic system using various wired and/or wireless interconnection and communication technologies, such as buses and networks. Examples technologies may include Inter-Integrated Circuit (I²C), Serial Peripheral Interface (SPI), PS/2, Universal Serial bus (USB), Bluetooth®, Infrared Data Association (IrDA), and various radio frequency (RF) communication protocols defined by the IEEE 802.11 standard.

The display 130 may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. For example, the display 130 may include an array of pixel elements (e.g., liquid crystal capacitors) coupled to a gate driver and a source driver (not shown for simplicity). Each row of pixel elements may be coupled to the gate driver via a respective gate line. Each column of pixel elements may be coupled to the source driver via a respective source line (or data line). In some aspects, the display 130 may be updated by successively “scanning” the rows of pixel elements (e.g., one row at a time), until each row of pixel elements has been updated.

In some embodiments, the input device 100 may correspond to a position sensor device (e.g., also referred to as a “touchpad,” “touch sensor device,” or “proximity sensor device”) configured to sense input provided by one or more input objects 140 in a sensing region 120 associated with the display 130. Example input objects 140 include fingers, styli, and the like. The sensing region 120 may encompass any space above, around, in, and/or proximate to the display 130 in which the input device 100 is able to detect user input (such as provided by one or more input objects 140). In some embodiments, the sensing region 120 may overlap at least part of an active area of the display 130. For example, the input device 100 may comprise a touch screen interface for the associated electronic system.

The size, shape, and/or location of the sensing region 120 may vary depending on actual implementations. In some embodiments, the sensing region 120 may extend from a surface of the input device 100 in one or more directions in space, for example, until a signal-to-noise ratio (SNR) of the sensors falls below a threshold suitable for object detection. In some embodiments, the sensing region 120 may detect inputs involving no physical contact with any surface of the input device 100, contact with an input surface (e.g., a touch surface and/or screen) of the input device 100, contact with an input surface of the input device 100 coupled with some amount of applied force or pressure, and/or any combination thereof.

In some embodiments, input surfaces may be provided by, and/or projected on, one or more surfaces of a housing of the input device 100 (e.g., as an image). For example, the sensing region 120 may have a rectangular shape when projected onto an input surface of the input device 100. In some aspects, inputs may be provided through images spanning one, two, three, or higher dimensional spaces in the sensing region 120. In some other aspects, inputs may be provided through projections along particular axes or planes in the sensing region 120. Still further, in some aspects, inputs may be provided through a combination of images and projections in the sensing region 120.

The display device may utilize various sensing technologies to detect user input. Example sensing technologies may include capacitive, elastive, resistive, inductive, magnetic, acoustic, ultrasonic, and optical sensing technologies. In some embodiments, the input device 100 may utilize capacitive sensing technologies to detect user inputs. For example, the sensing region 120 may include one or more capacitive sensing elements (e.g., sensor electrodes) to create an electric field. The input device 100 may detect inputs based on changes in capacitance of the sensor electrodes. In some other embodiments, the input device 100 may utilize optical sensing technologies to detect user inputs and/or identify features of an input object (e.g., a fingerprint). For example, the sensing region 120 may include one or more optical sensors (e.g., photodiodes, CMOS image sensor arrays, CCD arrays, and/or any other sensors capable of detecting wavelengths of light in the visible, infrared, and/or the ultraviolet spectrum) configured to detect objects through imaging or detecting changes in optical patters in the sensing region 120.

In some embodiments, the processing system 110 may be implemented as a set of modules that are implemented in firmware, software, or a combination thereof. Example modules include hardware operation modules for operating hardware such as sensor electrodes and display screens; data processing modules for processing data such as sensor signals and positional information; and reporting modules for reporting information. In some embodiments, the processing system 110 may include sensor operation modules configured to operate sensing elements to detect user input in the sensing region 120; identification modules configured to identify gestures such as mode changing gestures; and mode changing modules for changing operation modes of the input device 100 and/or electronic system.

The processing system 110 may respond to user input in the sensing region 120 by triggering one or more actions. Example actions include changing an operation mode of the input device 100 and/or graphical user interface (GUI) actions such as cursor movement, selection, menu navigation, and the like. In some embodiments, the processing system 110 may provide information about the detected input to the electronic system (e.g., to a central processing unit (CPU)). The electronic system may then process information received from the processing system 110 to carry out additional actions (e.g., changing a mode of the electronic system and/or GUI actions).

The processing system 110 may be configured to execute instructions related to sensing inputs via the sensing region 120 and updating the display 130. In some embodiments, the display 130 may share physical elements with sensor components of the sensing region 120. For example, one or more sensor electrodes may be used in displaying a visual interface and sensing inputs. More specifically, a display electrode used for displaying at least a portion of the visual interface may also operate as a sensor electrode used for sensing inputs. For example, the processing system 110 may drive a display electrode to update at least a portion of the display 130 and sense user inputs, concurrently. In another example, the processing system 110 may drive a first display electrode to update at least a portion of the display 130 while concurrently driving a second display electrode to sense user inputs.

The input device 100 may further include a camera 150. In some embodiments, the camera 150 may be used to authenticate a user of the input device 100 attempting to access (e.g., unlock) the electronic system and/or one or more applications provided thereon. For example, the input device 100 may be configured to capture an image of a user (e.g., specifically of the user's face, eyes, palm, ear, and/or various other body parts), via the camera 150, and compare the captured image with stored authentication data (e.g., reference images of one or more authorized users). The input device 100 may then determine, based on the comparison, whether the user of the input device 100 is an authorized user. Accordingly, the camera-based authentication scheme may be used to biometrically verify the user's identity.

As described above, camera-based authentication schemes may provide varying levels of security depending on the degree of user interaction or involvement requirement in capturing the image. For example, a low-security camera-based authentication scheme may authenticate the user's identity based on a limited number of data points from the captured image (such as a general alignment of the user's eyes, nose, mouth, and/or other easily identifiable features). Such authentication schemes may be able to “authenticate” the user in an image from various camera angles, distances, and/or poses. Although such authentication schemes may be convenient for the user to implement, they also may be easily spoofed (e.g., using a previously captured photograph of the user).

On the other hand, a high-security camera-based authentication scheme may authenticate the user's identity based on very specific data points that should be clearly visible from the captured image (such as the pattern of fibers in the user's iris). Such authentication schemes may be able to authenticate the user in an image only if the image is captured from a very specific angle, distance, and/or pose, or alternatively their performance may suffer if the image is not captured from the specific angle, distance, and/or pose. Although such authentication schemes are much more difficult to spoof, they also may involve a greater degree of interaction and/or attention from the user (e.g., to capture an image with the proper angle, distance, and/or pose).

Aspects of the present disclosure recognize the trade-off between security and convenience in camera-based authentication schemes. For example, certain applications (e.g., banking applications) may prioritize security over user convenience at all times, whereas other applications (e.g., messaging applications) may sometimes prioritize user convenience over security. Thus, in some embodiments, the input device 100 may be configured to dynamically adjust the parameters or tolerances of the camera-based authentication scheme based at least in part on a desired security level. More specifically, the input device 100 may select a set of parameters (e.g., from a plurality of available parameters) that involves a relatively low degree of user involvement when the security requirements associated with a particular instance of camera-based authentication are low. On the other hand, the input device 100 may select a set of parameters that involves a relatively high degree of user involvement when the security requirements associated with a particular instance of camera-based authentication are high.

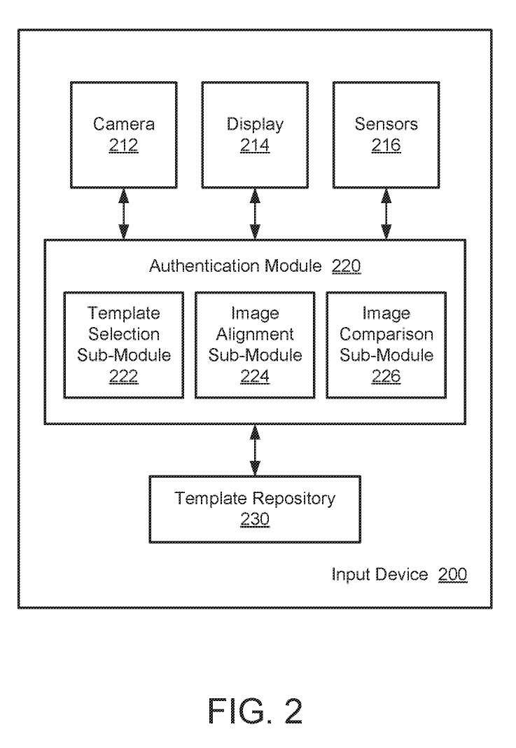

FIG. 2 is a block diagram of an input device 200 capable of generating a dynamic interface for camera-based authentication, in accordance with some embodiments. For example, the input device 200 may be an embodiment of the input device 100 of FIG. 1. The input device 200 includes a camera 212, a display 214, a number of sensors 216, and an authentication module 220.

The camera 212 may be configured to capture images (e.g., including still-frame images and/or video) of objects in proximity of the input device 200. For example, the camera 212 may comprise one or more optical sensors (e.g., photodiodes, CMOS image sensor arrays, CCD array, and/or any other sensors capable of detecting wavelengths of light in the visible spectrum, the infrared spectrum, and/or the ultraviolet spectrum) capable of capturing high-resolution images. In some embodiments, the images captured by the camera 212 may be presented in the display 214.

The display 214 may be configured to display a visual interface to a user of the input device. For example, the display 214 may include a screen or panel (e.g., comprising LED, OLED, CRT, LCD, EL, plasma, or other display technology) upon which the visual interface may be rendered and/or projected. In some embodiments, the display 214 may coincide, at least in part, with a sensing region (not shown for simplicity) of the input device 200. The sensing region may encompass any space above, around, in and/or proximate to the input device 200 in which the input device 200 is able to detect user input.

The sensors 212 may detect inputs in the sensing region using various sensing technologies (such as described with respect to FIG. 1). In some embodiments, the sensors 212 may include capacitive sensors (e.g., sensor electrodes) configured to detect touch inputs in the sensing region using capacitive sensing technologies. In some other embodiments, the sensors 212 may include biometric sensors (e.g., fingerprint scanners, voice recognition systems, eye scanners, and the like) configured to detect and/or identify various biometrics of the user.

The authentication module 220 is coupled to each of the camera 212, the display 214, and the sensors 216. The authentication module 220 may be implemented by, or include at least a portion of, a processing system (such as processing system 110 of FIG. 1) that controls an operation of the camera 212, display 214, sensors 216, and/or input device 200. In some embodiments, the authentication module 220 may be configured to authenticate a user of the input device 100 attempting to access (e.g., unlock) the electronic system and/or one or more applications provided thereon. More specifically, the authentication module 220 may attempt to verify the user's identity based, at least in part, on an image captured via the camera 212 (e.g., using a camera-based authentication scheme). The authentication module 220 may include a template selection sub-module 222, an image alignment sub-module 224, and an image comparison sub-module 226.

The template selection sub-module 222 may select a positioning template to be used for a particular instance of camera-based authentication. In some embodiments, the template selection sub-module 222 may select the positioning template from a template repository 230. For example, the template repository 230 may store a plurality of preconfigured positioning templates available for use with the camera-based authentication scheme. Each positioning template may include one or more visual cues configured to be aligned with one or more features of the image captured by the camera 212 (e.g., the image of the user). In some aspects, the selected positioning template may be displayed, concurrently with the image of the user, in the visual interface of the display 214. For example, the selected positioning template may be displayed as a graphic overlay of the image in the visual interface. Accordingly, the visual cues provided in the positioning template may guide the user of the input device 200 in adjusting the distance, angle, and/or pose of the image of the user to conform with a desired position for proper authentication.

In some embodiments, the template repository 230 may include one or more “generic” positioning templates that can be used to align a plurality of different faces. In some other embodiments, the template repository 230 may include one or more user-specific positioning templates. For example, a user-specific positioning template may be generated from data captured during an enrollment process in which the user of the input device 200 enrolls one or more images to be used for subsequent camera-based authentication (e.g., “reference images”). Accordingly, the user-specific positioning template may include one or more visual cues that are specifically aligned with corresponding features of the particular user from one or more of the reference images. More specifically, the user-specific positioning template may guide the user to match the particular pose, position, and/or image capture distance as that of a reference image.

In some embodiments, the template selection sub-module 222 may select the positioning template (e.g., to be displayed in the visual interface) based on a security level associated with the particular instance of camera-based authentication. For example, each of the plurality of positioning templates may correspond with a different security level. In some aspects, positioning templates associated with higher security levels may include more visual cues (e.g., to be aligned with the features of the image) than positioning templates associated with lower security levels. In other aspects, positioning templates associated with high security levels may correspond with closer image capture distances (e.g., less distance between the camera 212 and the body part used for authentication increases).

In some embodiments, the security level associated with a particular instance of camera-based authentication may be determined based, at least in part, on the type of device and/or application to be accessed. For example, mobile phones and banking applications (e.g., which prioritize security over user convenience) may require a higher security level than gaming consoles or messaging applications (e.g., which often prioritize user convenience over security). Thus, when the user attempts to access a device or application requiring a relatively high level of security (such as a mobile phone or banking application), the template selection sub-module 222 may select a positioning template with more visual cues and/or stricter positioning requirements (e.g., tolerance for the angle, distance, and/or pose of the image of the user). On the other hand, when the user attempts to access a device or application requiring a relatively low level of security (such as a gaming console or messaging application), the template selection sub-module 222 may select a positioning template with fewer visual cues and/or more relaxed positioning requirements.

In some implementations, the camera-based authentication scheme may be part of a multi-modal authentication attempt. For example, a multi-modal authentication attempt may utilize multiple biometrics (e.g., face recognition, palm recognition, voice recognition, fingerprint scanning, eye scanning, etc.) to authenticate the user. Because multi-modal authentication typically involve several different biometric inputs, the false acceptance rate (e.g., likelihood of successfully authenticating an unauthorized user) of a multi-modal authentication attempt may be significantly lower than that of any authentication scheme using only a single biometric input. Accordingly, the requirements imposed on the camera-based authentication scheme (e.g., when part of a multi-modal authentication attempt) may be relaxed while still maintaining a relatively high level of security overall for the multi-modal authentication attempt.

In some embodiments, the security level associated with the camera-based authentication scheme may be determined based, at least in part, on whether the particular instance of camera-based authentication is part of a multi-modal authentication attempt. For example, the template selection sub-module 222 may attribute a lower security level to the camera-based authentication scheme (e.g., and select a positioning template with fewer visual cues and/or more relaxed positioning requirements) when the instance of camera-based authentication is part of a multi-modal authentication attempt. On the other hand, the template selection sub-module 222 may attribute a higher security level to the camera-based authentication scheme (e.g., and select a positioning template with more visual cues and/or stricter positioning templates) when the instance of camera-based authentication is not part of a multi-modal authentication attempt (e.g., the particular instance of camera-based authentication corresponds to a single-mode authentication attempt).

In some embodiments, the security level associated with the camera-based authentication scheme may be determined based, at least in part, on the number of authentication modes (e.g., number of different biometric inputs) of a corresponding multi-modal authentication attempt. For example, the template selection sub-module 222 may attribute a lower security level to the camera-based authentication scheme when the instance of camera-based authentication is part of a multi-modal authentication attempt with a relatively large number of authentication modes. Accordingly, the template selection sub-module 222 may select a positioning template with fewer visual cues and/or more relaxed positioning requirements when the multi-modal authentication attempt includes a relatively large number of authentication modes (e.g., corresponding to an abundance in biometric diversity).

On the other hand, the template selection sub-module 222 may attribute a higher security level to the camera-based authentication scheme when the instance of camera-based authentication is part of a multi-modal authentication attempt with a relatively small number of authentication modes. Accordingly, the template selection sub-module 222 may select a positioning template with more visual cues and/or stricter positioning requirements when the multi-modal authentication attempt includes a relatively small number of authentication modes (e.g., corresponding to a lack of biometric diversity). In some aspects, the template selection sub-module 222 may select a positioning template with no visual cues if there are at least a threshold number of authentication modes in the multi-modal authentication scheme.

In some other implementations, the camera-based authentication scheme may be part of a multi-factor authentication scheme. For example, a multi-factor authentication scheme may authenticate a user based on multiple factors. Example authentication “factors” include: something the user knows (e.g., username and password), something the user has (e.g., security token or device identifier), and something the user is (e.g., personal identifier or biometric). Because multi-factor authentication schemes typically require a user to provide several different forms of verification, the false acceptance rate of a multi-factor authentication scheme may be significantly lower than that of any authentication scheme using only a single form of authentication. Accordingly, the requirements imposed on the camera-based authentication scheme (e.g., when part of a multi-factor authentication scheme) may be relaxed while still maintaining a relatively high level of security overall for the multi-factor authentication scheme.

In some embodiments, the security level associated with the camera-based authentication scheme may be determined based, at least in part, on whether the particular instance of camera-based authentication is part of a multi-factor authentication attempt. For example, the template selection sub-module 222 may attribute a lower security level to the camera-based authentication scheme (e.g., and select a positioning template with fewer visual cues and/or more relaxed positioning requirements) when the instance of camera-based authentication is part of a multi-factor authentication attempt. On the other hand, the template selection sub-module 222 may attribute a higher security level to the camera-based authentication scheme (e.g., and select a positioning template with more visual cues and/or stricter positioning templates) when the instance of camera-based authentication is not part of a multi-factor authentication attempt (e.g., the particular instance of camera-based authentication corresponds to a single-factor authentication attempt).

In some embodiments, the security level associated with the camera-based authentication scheme may be determined based, at least in part, on the number of authentication factors (e.g., number of different forms of authentication) of a corresponding multi-factor authentication scheme. For example, the template selection sub-module 222 may attribute a lower security level to the camera-based authentication scheme when the camera-based authentication scheme is part of a multi-factor authentication scheme with a relatively large number of authentication factors. Accordingly, the template selection sub-module 222 may select a positioning template with fewer visual cues and/or more relaxed positioning requirements when the multi-factor authentication scheme includes a relatively large number of authentication factors (e.g., corresponding to an abundance of diversity in the forms of verification).

On the other hand, the template selection sub-module 222 may attribute a higher security level to the camera-based authentication scheme when the camera-based authentication scheme is part of a multi-factor authentication scheme with a relatively small number of authentication factors. Accordingly, the template selection sub-module 222 may select a positioning template with more visual cues and/or stricter positioning requirements when the multi-factor authentication scheme includes a relatively small number of authentication factors (e.g., corresponding to a lack of diversity in the forms of verification). In some aspects, the template selection sub-module 222 may select a positioning template with no visual cues if there are at least a threshold number of authentication factors in the multi-factor authentication scheme.

The image alignment sub-module 224 may determine whether one or more features from the image of the user are aligned with corresponding visual cues in the selected positioning template. For example, the image alignment sub-module 224 may present the selected positioning template, concurrently with the image of the user, in the visual interface of the display 214. As described above, the selected positioning template may include one or more visual cues that should be aligned with corresponding features of the image of the user for proper authentication (e.g., based on the security level of the camera-based authentication scheme). For example, the visual cues may indicate how one or more facial features (e.g., eyes, nose, ears, chin, brow, etc.) should be positioned in order for the authentication module 220 to verify the identity of the user. Thus, the visual cues provided in the positioning template may guide the user of the input device 200 in adjusting the distance, angle, and/or pose of the image of the user to conform with a position desired for proper authentication.

In some embodiments, the image alignment sub-module 224 may continuously display the image of the user, concurrently with the selected positioning template, until the image is properly aligned with the one or more visual cues (e.g., thus preventing unauthorized access to the secured application and/or device). For example, the image alignment sub-module 224 may update the image of the user, in the visual interface, in real-time. This allows the user to make incremental adjustments to the distance, angle, and/or pose of the image until the image of the user is properly aligned with the one or more visual cues of the selected positioning template. As described above, the amount of user interaction involved to properly align the image with the selected positioning template may depend on the security level associated with the security template. For example, positioning templates associated with higher levels of security may prompt the user to provide greater manipulation of the camera and/or user's body (e.g., face, eyes, palm, and/or various other body parts) to ensure proper alignment. On the other hand, positioning templates associated with lower levels of security may prompt the user to provide less manipulation of the camera and/or user's body to achieve an adequate degree of alignment. In some embodiments, the image alignment sub-module 224 may allow the image to be analyzed for authentication only upon detecting a proper alignment between the image of the user and the selected positioning template.

When the image of the user is aligned with the selected positioning template, the image comparison sub-module 226 may compare an authentication image (e.g., an image of the user to be verified and/or authenticated) with stored authentication data. In some aspects, the authentication image may correspond to the image captured by the camera 212 (e.g., the image aligned with the selected positioning template). In other aspects, the authentication image may be captured by a different camera than the camera 212 used for aligning the user with the selected positioning template. For example, a secondary camera (such as a 3D camera, infrared camera, or dedicated biometric camera) may capture the authentication image when the image alignment sub-module 224 determines that one or more features of the user (e.g., the user's face and/or body position) are properly aligned with the selected positioning template (e.g., based on the image captured by the camera 212 or the image captured by the secondary camera).

In some embodiments, the secondary camera may have a more limited field of view than the camera 212 used for aligning the user with the selected positioning template. Thus, the selected positioning template may be configured to guide one or more features of the user (such as the user's face, eyes, palm, and/or various other body parts) into position within (e.g., at least a threshold tolerance of) the secondary camera's field of view. In some aspects, the image comparison sub-module 226 may cause the secondary camera to capture the authentication image when one or more features of the user are located within a threshold tolerance of the secondary camera's field of view. In other aspects, the secondary camera may capture a continuous sequence of images (e.g., video frames). Thus, the image comparison sub-module 226 may select the authentication image, from the sequence of images captured by the secondary camera, when one or more features of the user are located within a threshold tolerance of the secondary camera's field of view.

The authentication data may be based, at least in part, on reference images of one or more authorized users of the requested application and/or device (e.g., acquired during a training or enrollment process). In some embodiments, the image comparison sub-module 226 may implement one or more facial recognition algorithms to identify similarities between the features of the user's face (e.g., relative size and/or position of the user's eyes, nose, mouth, ears, etc.) and corresponding facial features of one or more authorized users (e.g., based on stored images of the authorized users). In some other embodiments, the image comparison sub-module 226 may implement one or more palm recognition algorithms to identify similarities between the features of the user's palm (e.g., skin texture, hand geometry, etc.) and corresponding palm features of one or more authorized users. The image comparison sub-module 226 may allow access to the requested application and/or device only if a match is detected between the image of the user and the stored authentication data.

In some embodiments, one or more positioning templates (e.g., from the template repository 230) may be used during an enrollment process to capture the reference images. For example, it may be desirable to ensure that the user of the input device 200 captures images with the proper pose, position, and/or image capture distance to be aligned with the one or more positioning templates. Thus, by displaying positioning templates during the enrollment process, the input device 200 may guide the user in enrolling images that can be subsequently used with the one or more positioning templates already stored in the template repository 230.

Still further, in some embodiments, the image comparison sub-module 226 may dynamically update the positioning templates stored in the template repository 230 based on new images of the user (e.g., captured during the camera-based authentication). For example, when comparing the authentication image to one or more reference images, the image comparison sub-module 226 may detect differences in the pose, position, and/or image capture distance of the authentication image. Accordingly, the image comparison sub-module 226 may update the plurality of positioning templates (e.g., by adding new positioning templates and/or modifying existing positioning templates) so that the updated visual cues reflect the pose, position, and/or image capture distance from the newly captured authentication image.

As described above, the authentication module 220 may dynamically adjust the degree of user interaction required by the camera-based authentication scheme to satisfy a continuum of security levels. For example, the authentication module 220 may require a greater degree of concentration and/or involvement by the user (e.g., by displaying a positioning template with more visual cues and/or more restrictive positioning requirements) to satisfy the authentication requirements when the camera-based authentication scheme is associated with a higher security level. On the other hand, the authentication module 220 may require a lesser degree of concentration and/or involvement by the user (e.g., by displaying a positioning template with fewer visual cues and/or less restrictive positioning requirements) to satisfy the authentication requirements when the camera-based authentication scheme is associated with a lower security level. More specifically, in determining which of the various positioning templates to display to the user, the authentication module 220 may balance user convenience with the security of the device and/or application to be accessed (e.g., based on the type of device and/or application, number of authentication modes, and/or number of authentication factors).

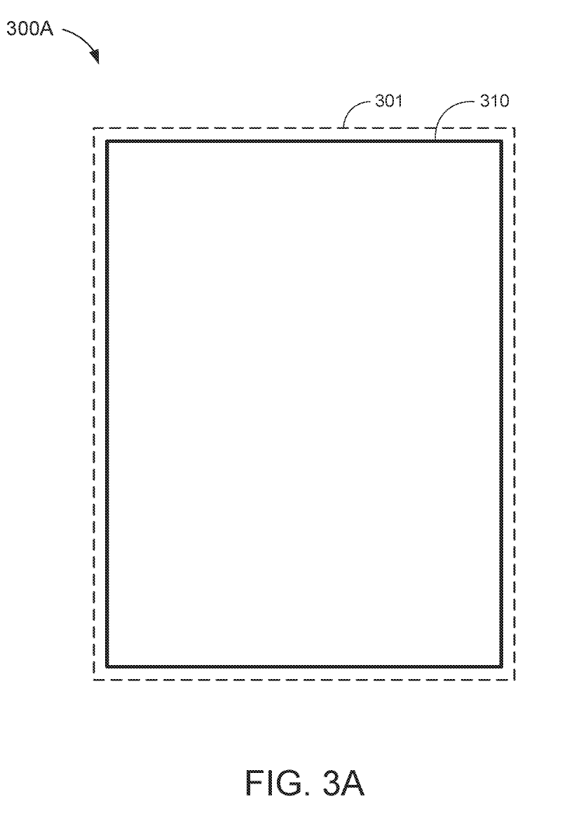

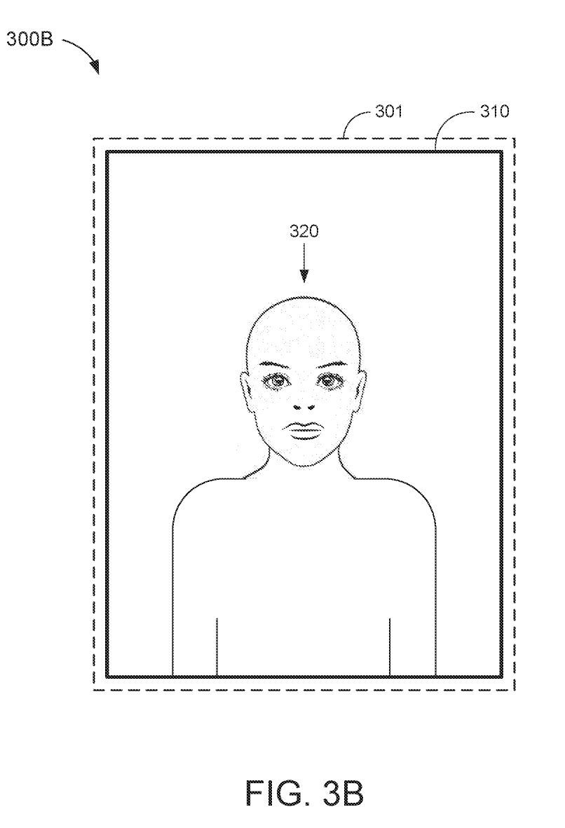

FIGS. 3A and 3B show example visual interfaces 300A and 300B, respectively, depicting a positioning template 310 that may be used in camera-based authentication schemes with relaxed security requirements. More specifically, FIG. 3A depicts the positioning template 310 in a display area 301 of the visual interface 300A, whereas FIG. 3B depicts the positioning template 310 as an overlay of an image 320 of the user. With reference for example to FIG. 2, the authentication module 220 may display the positioning template 310 in the visual interface of the display 214 when triggering a low-security camera-based authentication scheme.

In some embodiments, the authentication module 220 may select the positioning template 310 to be displayed when the user attempts to access a device and/or application with a low security setting. In other embodiments, the authentication module 220 may select the positioning template 310 to be displayed when the camera-based authentication scheme is triggered as part of a multi-modal authentication scheme with a large number of authentication modes. Still further, in some embodiments, the authentication module 220 may select the positioning template 310 to be displayed when the camera-based authentication scheme is triggered as a part of a multi-factor authentication scheme with a large number of authentication factors.

In the example of FIG. 3A, the positioning template 310 may be presented as a rectangular frame substantially bordering the edges of the display area 301. For example, the visual cues associated with the positioning template 310 may correspond to the edges of the rectangular frame. In some embodiments, the positioning template 310 may have very relaxed positioning requirements. For example, the authentication module 220 may determine that an image of a user is aligned with the positioning template 310 as long as the user's face is positioned within the corresponding rectangular frame. It is noted that the region bounded by the rectangular frame encompasses most, if not all, of the display area 301. Thus, the authentication module 220 may tolerate significant variations in angle, distance, and/or pose when determining whether the image of the user is aligned with the positioning template 310.

In the example of FIG. 3B, the user's image 320 is positioned within the rectangular frame of the positioning template 310. It is noted that the image capture distance (e.g., distance between the camera and the user's face when the image 320 is captured) is relatively far. For example, the size of the user's face is small relative to the size of the display area 301, and other body parts (such as the user's arms and torso) can be seen in the image 320. However, because the user's facial features are located within the region bounded by the positioning template 310, the authentication module 220 may determine that the image 320 is properly aligned with the positioning template 310. Thus, the positioning template 310 may require very little involvement (e.g., camera and/or facial manipulation) by the user in order to satisfy the authentication requirements of the corresponding camera-based authentication scheme. In some embodiments, the authentication module 220 may implement the positioning template 310 for camera-based authentication schemes that heavily prioritize user convenience (e.g., over security).

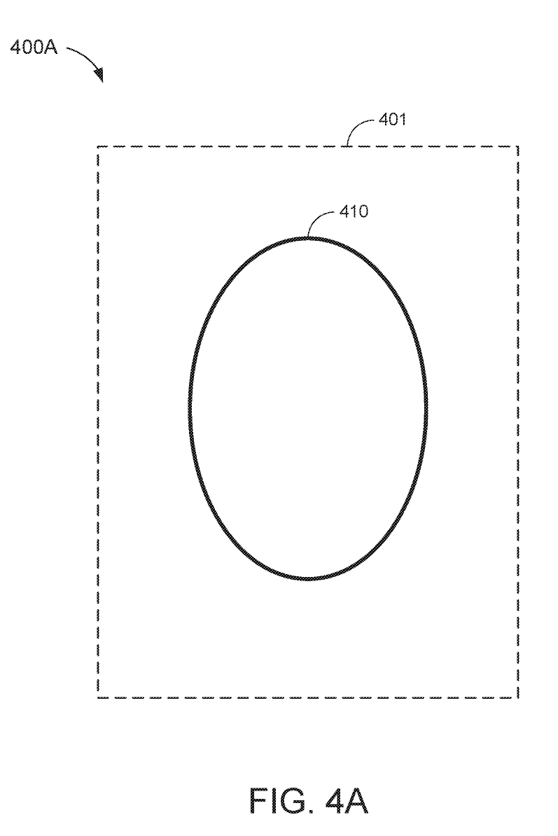

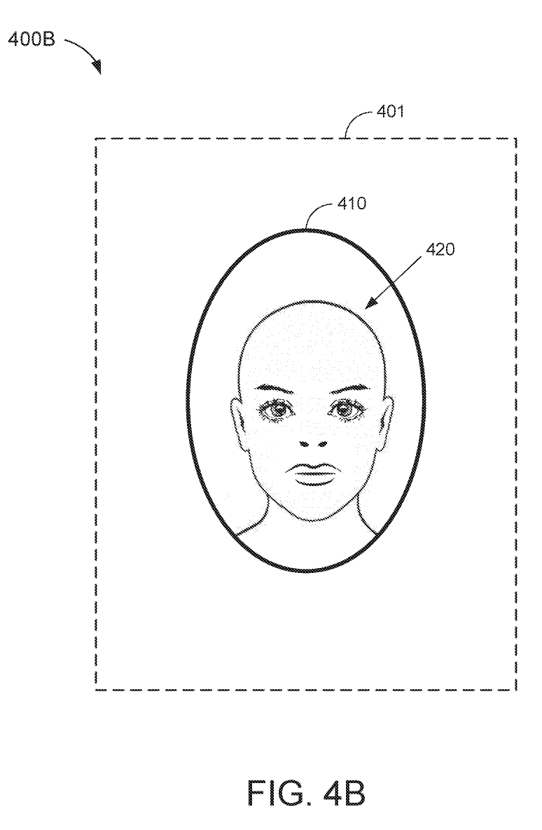

FIGS. 4A and 4B show example visual interfaces 400A and 400B, respectively, depicting a positioning template 410 that may be used in camera-based authentication schemes with relatively relaxed security requirements. More specifically, FIG. 4A depicts the positioning template 410 in a display area 401 of the visual interface 400A, whereas FIG. 4B depicts the positioning template 410 as an overlay of an image 420 of the user. With reference for example to FIG. 2, the authentication module 220 may display the positioning template 410 in the visual interface of the display 214 when triggering a relatively low-security camera-based authentication scheme.

In some embodiments, the authentication module 220 may select the positioning template 410 to be displayed when the user attempts to access a device and/or application with a relatively low security setting. In other embodiments, the authentication module 220 may select the positioning template 410 to be displayed when the camera-based authentication scheme is triggered as part of a multi-modal authentication scheme with a relatively large number of authentication modes. Still further, in some embodiments, the authentication module 220 may select the positioning template 410 to be displayed when the camera-based authentication scheme is triggered as part of a multi-factor authentication scheme with a relatively large number of authentication factors.

In the example of FIG. 4A, the positioning template 410 may be presented as an oval frame substantially centered within the display area 401. For example, the visual cues associated with the positioning template 410 may correspond to the edges of the oval frame. In some embodiments, the positioning template 410 may have more stringent positioning requirements than the positioning template 310 of FIGS. 3A and 3B. For example, the authentication module 220 may determine that an image of a user is aligned with the positioning template 410 only if the user's face is positioned (e.g., substantially centered) within the corresponding oval frame. It is noted that the region bounded by the oval frame is substantially smaller than the region bounded by the rectangular frame of positioning template 310. Thus, the authentication module 220 may not tolerate as much variation in angle, distance, and/or pose when determining whether the image of the user is aligned with the positioning template 410 (e.g., compared to the implementation of the positioning template 310).

In the example of FIG. 4B, the user's image 420 is positioned within the oval frame of the positioning template 410. It is noted that the image capture distance of the image 420 is substantially closer than that of the image 320. For example, the user's face is much larger and more prominently featured in the image 420 than in the image 320 (e.g., and other body parts cannot be seen). Moreover, since the user's face substantially fills the region bounded by the positioning template 410, the authentication module 220 may determine that the image 420 is properly aligned with the positioning template 410. Thus, the positioning template 410 may require slightly more involvement (e.g., camera and/or facial manipulation) by the user in order to satisfy the authentication requirements of the corresponding camera-based authentication scheme (e.g., compared to the positioning template 310). In some embodiments, the authentication module 220 may implement the positioning template 410 for camera-based authentication schemes that slightly prioritize user convenience (e.g., over security).

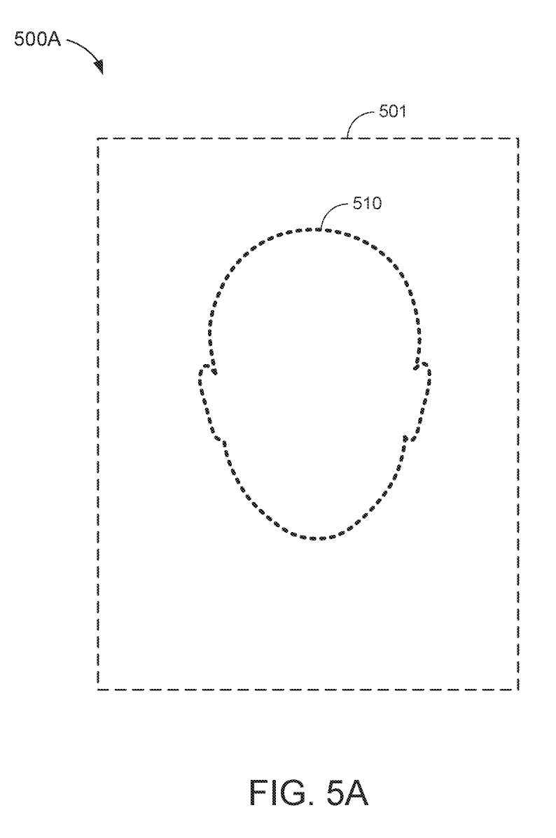

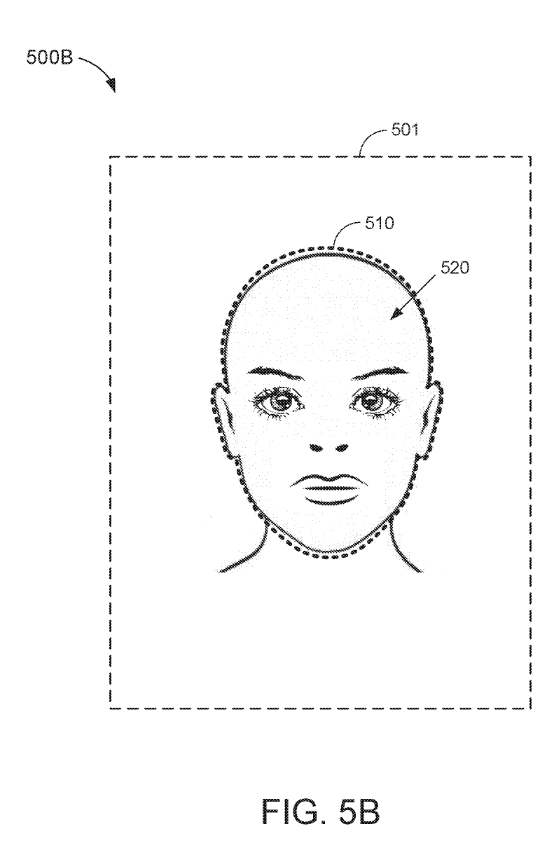

FIGS. 5A and 5B show example visual interfaces 500A and 500B, respectively, depicting a positioning template 510 that may be used in camera-based authentication schemes with relatively strict security requirements. More specifically, FIG. 5A depicts the positioning template 510 in a display area 501 of the visual interface 500A, whereas FIG. 5B depicts the positioning template 510 as an overlay of an image 520 of the user. With reference for example to FIG. 2, the authentication module 220 may display the positioning template 510 in the visual interface of the display 214 when triggering a relatively high-security camera-based authentication scheme.

In some embodiments, the authentication module 220 may select the positioning template 510 to be displayed when the user attempts to access a device and/or application with a relatively high security setting. In other embodiments, the authentication module 220 may select the positioning template 510 to be displayed when the camera-based authentication scheme is triggered as part of a multi-modal authentication scheme with a relatively small number of authentication modes. Still further, in some embodiments, the authentication module 220 may select the positioning template 510 to be displayed when the camera-based authentication scheme is triggered as part of a multi-factor authentication scheme with a relatively small number of authentication factors.

In the example of FIG. 5A, the positioning template 510 may be presented as an outline or silhouette of a face substantially centered within the display area 501. For example, the visual cues associated with the positioning template 510 may correspond to the edges of the silhouette (e.g., including the outline of the ears, chin, and top of the head). In some embodiments, the positioning template 510 may have more stringent positioning requirements than the positioning template 410 of FIGS. 4A and 4B. For example, the authentication module 220 may determine than an image of a user is aligned with the positioning template 510 only if the edges of the user's face (e.g., ears, chin, and top of the head) are in alignment with the placement of such features in the silhouette. Thus, the authentication module 220 may tolerate even less variation in angle, distance, and/or pose when determining whether the image of the user is aligned with the positioning template 510 (e.g., compared to the implementation of the positioning template 410).

In some embodiments, the silhouette may be based on an authorized user's face. For example, the silhouette may be generated by tracing a stored image of a particular authorized user's face. In such embodiments, the authentication module 220 may expect a near-perfect match between the user's facial features and the silhouette of the positioning template 510 (e.g., for proper alignment). In other embodiments, the silhouette may be a generic outline of a face (e.g., not based on the actual face of any particular individual). In such embodiments, the authentication module 220 may tolerate a slight (e.g., threshold amount of) deviation between the user's facial features and the silhouette of the positioning template 510.

In the example of FIG. 5B, the user's image 520 is positioned within the silhouette of the positioning template 510. It is noted that the image capture distance of the image 520 is substantially closer than that of the image 420. For example, the user's face is much larger and more prominently featured in the image 520 than in the image 420. Moreover, since the edges of the user's face closely match the outline of the positioning template 510, the authentication module 220 may determine that the image 520 is properly aligned with the positioning template 510. Thus, the positioning template 510 may require even more involvement (e.g., camera and/or facial manipulation) by the user in order to satisfy the authentication requirements of the corresponding camera-based authentication scheme (e.g., compared to the positioning template 410). In some embodiments, the authentication module 220 may implement the positioning template 510 for camera-based authentication schemes that slightly prioritize security (e.g., over user convenience).

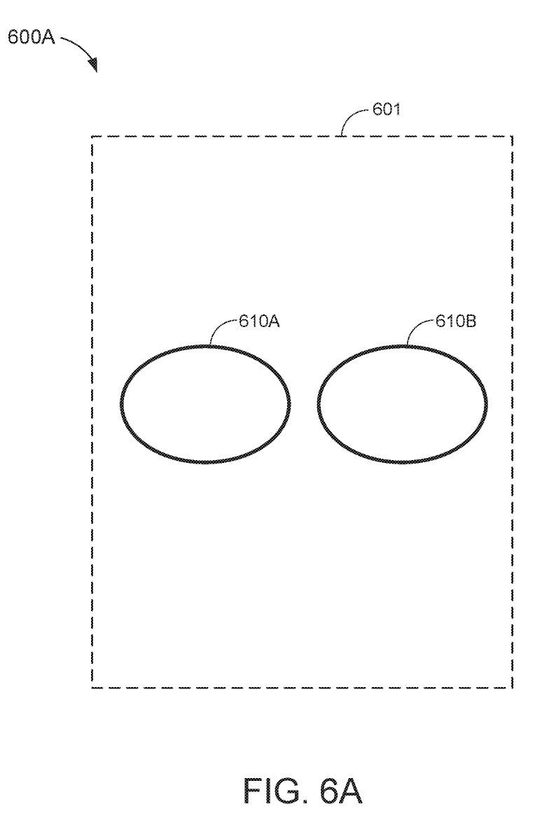

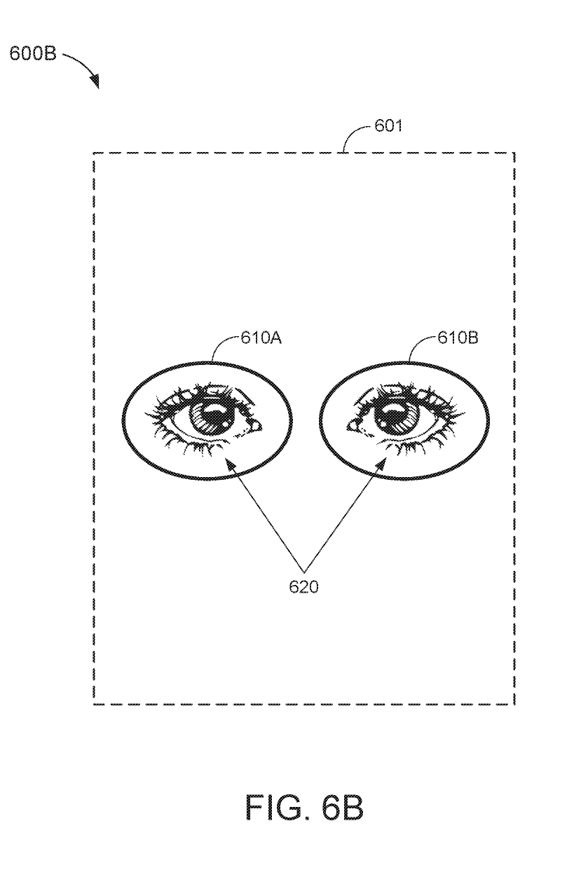

FIGS. 6A and 6B show example visual interfaces 600A and 600B, respectively, depicting a positioning template 610A and 610B that may be used in camera-based authentication schemes with strict security requirements. More specifically, FIG. 6A depicts the positioning template 610A and 610B in a display area 601 of the visual interface 600A, whereas FIG. 6B depicts the positioning template 610A and 610B as an overlay of an image 620 of the user. With reference for example to FIG. 2, the authentication module 220 may display the positioning template 610A and 610B in the visual interface of the display 214 when triggering a high-security camera-based authentication scheme.

In some embodiments, the authentication module 220 may select the positioning template 610A and 610B to be displayed when the user attempts to access a device and/or application with a high security setting. In other embodiments, the authentication module 220 may select the positioning template 610A and 610B to be displayed when the camera-based authentication scheme is triggered as part of a multi-modal authentication scheme with a small number of authentication modes. Still further, in some embodiments, the authentication module 220 may select the positioning template 610A and 610B to be displayed when the camera-based authentication scheme is triggered as part of a multi-factor authentication scheme with a small number of authentication factors.

In the example of FIG. 6A, the positioning template 610A and 610B may be presented as two circular outlines substantially centered within the display area 601. For example, the visual cues associated with the positioning templates 610A and 610B may correspond to the edges of the circular outlines (e.g., including a set of visual cues associated with the outline on the left and another set of visual cues associated with the outline on the right). In some embodiments, the positioning template 610A and 610B may have more stringent positioning requirements than the positioning template 510 of FIGS. 5A and 5B. For example, the authentication module 220 may determine that an image of a user is aligned with the positioning template 610A and 610B only if each of the user's eyes is aligned with a corresponding one of the circular outlines.

In some embodiments, the circular outlines of the positioning template 610A and 610B are for capturing a detailed image of the user's eyes. For example, the camera-based authentication scheme associated with the positioning template 610A and 610B may analyze the pattern of fibers in the user's iris and/or veins in the user's schlera. To capture such high level of detail, the user's eyes should be positioned close to the camera 212. Thus, the authentication module 220 may tolerate even less variation in angle, distance, and/or pose when determining whether the image of the user is aligned with the positioning template 610A and 610B (e.g., compared to the implementation of the positioning template 510).

In the example of FIG. 6B, the user's image 620 is positioned within the circular outlines of the positioning template 610A and 610B. It is noted that the image capture distance of the image 620 is substantially closer than that of the image 520. For example, the user's eyes are much larger and more prominently featured in the image 620 than in the image 520 (e.g., and other facial features cannot be seen). Moreover, since each of the user's eyes substantially fills a corresponding region bounded by the positioning template 610A and 610B, the authentication module 220 may determine that the image 620 is properly aligned with the positioning template 610A and 610B. Thus, the positioning template 610A and 610B may require even more involvement (e.g., camera and/or facial manipulation) by the user in order to satisfy the authentication requirements of the corresponding camera-based authentication scheme (e.g., compared to the positioning template 510). In some embodiments, the authentication module 220 may implement the positioning template 610A and 610B for camera-based authentication schemes that heavily prioritize security (e.g., over user convenience).

Although FIGS. 3A-6B provide specific examples of positioning templates that may be used to identify one or more features of a user's face, aspects of this disclosure are not limited to facial recognition. For example, in actual embodiments, the template repository 230 may store positioning templates for various other body parts (e.g., palm, ear, etc.) that can be used to identify and/or authenticate a user. Thus, the template selection sub-module 222 may select a positioning template for any desired body part based, at least in part, on the security level associated with the particular instance of camera-based authentication.

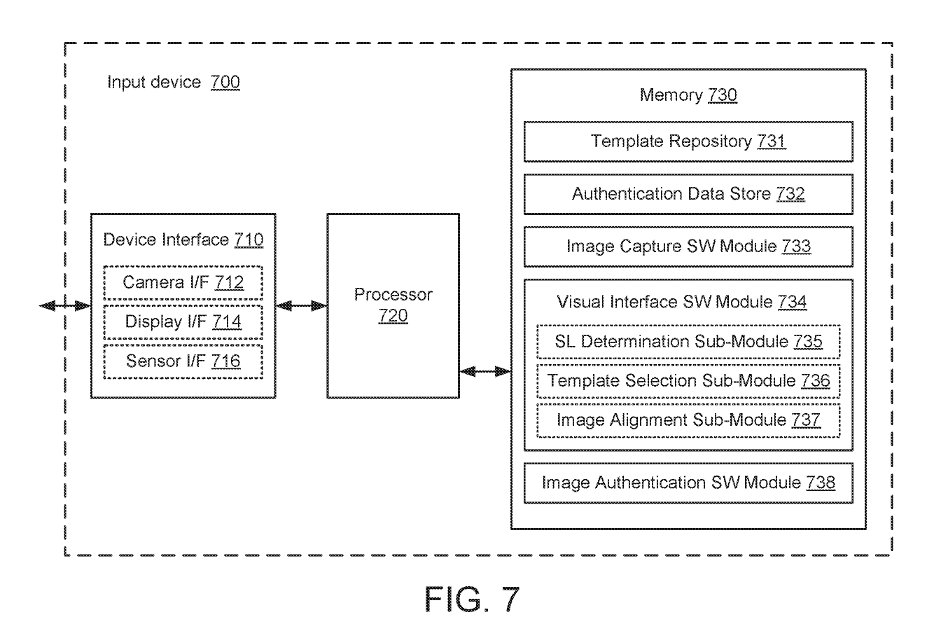

FIG. 7 is a block diagram of an input device 700 capable of generating a dynamic interface for camera-based authentication, in accordance with some other embodiments. The input device 700 may be an embodiment of the input device 100 of FIG. 1 and/or the input device 200 of FIG. 2. In some embodiments, the input device 700 may include a device interface 710, a processor 720, and a memory 730.

The device interface 710 may include a camera interface 712, a display interface 714, and a sensor interface 716. The camera interface 712 may be used to communicate with a camera of the input device 700 (such as camera 150 of FIG. 1 and/or camera 212 of FIG. 2). For example, the camera interface 712 may transmit signals to, and receive signals from, the camera to capture an image of a user in proximity of the input device 700. The display interface 714 may be used to communicate with a display of the input device 700 (such as display 130 of FIG. 1 and/or display 214 of FIG. 2). For example, the display interface 714 may transmit signals to the display to update a visual interface presented thereon. The sensor interface 716 may be used to communicate with one or more sensors of the input device 700 (such as sensors 216 of FIG. 2). For example, the sensor interface 716 may transit signals to, and receive signals from, the sensors to detect inputs in a sensing region of the input device 700 (such as sensing region 120 of FIG. 1).

The memory includes a template repository 731 and an authentication data store 732. The template repository 731 may store a plurality of positioning templates to be used for aligning an image of a user for camera-based authentication. For example, the template repository 731 may be an embodiment of template repository 230 of FIG. 2. The authentication data store 732 may store authentication data to be compared against images captured by the input device 700 to verify an identity of the user of the input device 700. For example, the authentication data store 732 may store reference images of one or more authorized users of a device and/or application associated with the input device 700. In some embodiments, the authentication data may be acquired during a training or enrollment process (e.g., when setting up a camera-based authentication scheme for the corresponding device and/or application). In some other embodiments, the positioning templates stored in the template repository 731 may be used to generate, and/or generated based on, the authentication data stored in the authentication data store 732 (e.g., as described with respect to FIG. 2).

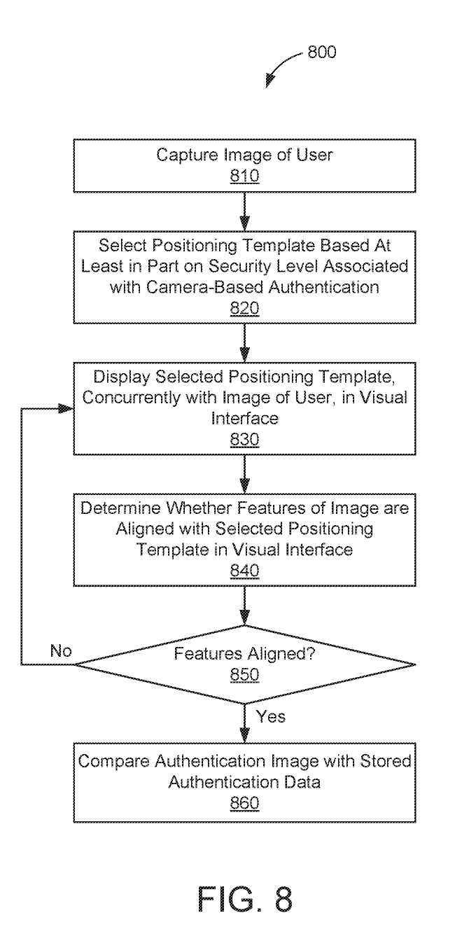

The memory 730 may also include a non-transitory computer-readable medium (e.g., one or more nonvolatile memory elements, such as EPROM, EEPROM, Flash memory, a hard drive, etc.) that may store at least the following software (SW) modules:
an image capture SW module 733 to capture an image of a user via the camera of the input device 700;
a visual interface SW module 734 to display the image of the user, concurrently with a positioning template, in the display of the input device 700, the visual interface SW module 734 further including:
   a security level (SL) determination sub-module 735 to determine a security level associated with the camera-based authentication scheme;
   a template selection sub-module 736 to select the positioning template (e.g., from the template repository 731) to be displayed concurrently with the image of the user based, at least in part, on the security level of the camera-based authentication scheme; and
   an image alignment sub-module 737 to determine whether the image of the user is aligned with the selected positioning template; and
an image authentication SW module 738 to compare an authentication image with authentication data stored in the authentication data store 732 when the image of the user is aligned with the selected positioning template.
   Each software module includes instructions that, when executed by the processor 720, cause the input device 700 to perform the corresponding functions. The non-transitory computer-readable medium of memory 730 thus includes instructions for performing all or a portion of the operations described below with respect to FIG. 8.

Processor 720 may be any suitable one or more processors capable of executing scripts or instructions of one or more software programs stored in the input device 700 (e.g., within memory 730). For example, the processor 720 may execute the image capture SW module 733 to capture an image of a user via the camera of the input device 700. The processor 720 may also execute the visual interface SW module 734 to display the image of the user, concurrently with a positioning template, in the display of the input device 700. Further, the processor 720 may execute the image authentication SW module 738 to compare an authentication image with authentication data stored in the authentication data store 732 when the image of the user is aligned with the selected positioning template, for example, to determine whether the user is authorized to access the requested device and/or application.

In executing the visual interface SW module 734, the processor 720 may further execute the SL determination sub-module 735, the template selection sub-module 736, and the image alignment sub-module 737. For example, the processor 720 may execute the SL determination sub-module 735 to determine a security level associated with the camera-based authentication scheme. The processor 720 may execute the template selection sub-module 736 to select the positioning template (e.g., from a plurality of positioning templates) to be displayed concurrently with the image of the user based, at least in part, on the security level of the camera-based authentication scheme. Further, the processor 720 may execute the image alignment sub-module 737 to determine whether the image of the user is aligned with the selected positioning template.

FIG. 8 is an illustrative flowchart depicting an example operation 800 for dynamically generating an interface for camera-based authentication. With reference for example to FIG. 2, the operation 800 may be performed by the input device 200 to determine whether a user of the input device 200 is authorized to access a requested device and/or application. More specifically, the operation 800 may balance user convenience with security in determining how stringent the positioning requirements (e.g., angle, distance, and/or pose) associated with the camera-based authentication scheme should be.

The input device 200 may first capture an image of the user (810). For example, the input device 200 may capture images of objects in proximity of the input device 200 using the camera 212. In some embodiments, the images captured by the camera 212 may be presented in a visual interface of the display 214. In some aspects, the images captured by the camera 212 may be continuously or periodically updated (e.g., as a video) to display any changes in the captured image from one frame to another.

The input device 200 may select a positioning template based at least in part on a security level associated with the camera-based authentication (820). For example, the template selection sub-module 222 may select the positioning template from a plurality of preconfigured positioning templates available for user with the camera-based authentication scheme. In some embodiments, each of the plurality of positioning templates may correspond with a different security level. In some aspects, the security level associated with the camera-based authentication scheme may be based on the type of device and/or application to be accessed, or determined from device context or one or more usage parameters. In other aspects, the security level associated with the camera-based authentication scheme may be based on the number of authentication modes of a multi-modal authentication scheme (e.g., where the camera-based authentication scheme is one authentication mode of the multi-modal authentication scheme). Still further, in some aspects, the security level associated with the camera-based authentication scheme may be based on the number of authentication factors of a multi-factor authentication scheme (e.g., where the camera-based authentication scheme is one authentication factor of the multi-factor authentication scheme).

The input device 200 may display the selected positioning template, concurrently with the image of the user, in the visual interface (830). For example, the selected positioning template may be displayed as a graphic overlay of the image in the visual interface. Each of the plurality of positioning templates may include one or more visual cues to be aligned with one or more features of the image of the user. More specifically, the visual cues provided in the positioning templates may guide the user of the input device 200 in adjusting the distance, angle, and/or pose of the image of the user to conform with a position required for proper authentication. In some embodiments, positioning templates associated with higher security levels may have more visual cues and/or stricter positioning requirements than positioning templates associated with lower security levels (e.g., as described with respect to FIGS. 3A-6B. Accordingly, the amount and/or degree of user interaction needed to properly align the image of the user with the selected positioning template may vary directly with the security level of the camera-based authentication scheme.

The input device 200 may then determine whether one or more features of the image are aligned with the selected positioning template in the visual interface (840). In some embodiments, the image alignment sub-module 224 may continuously display the image of the user, concurrently with the selected positioning template, until the image is properly aligned with the one or more visual cues (e.g., thus preventing unauthorized access to the secured application and/or device). For example, the image alignment sub-module 224 may update the image of the user, in the visual interface, in real-time. This allows the user to make incremental adjustments to the distance, angle, and/or pose of the image until the image of the user is properly aligned with the one or more visual cues of the selected positioning template. Thus, as long as the image of the user is not aligned with the selected positioning template (as tested at 850), the input device 200 may continue to display the selected positioning template, concurrently with the image of the user, in the visual interface (830).

Upon determining that the image of the user is aligned with the selected positioning template (as tested at 850), the input device may compare an authentication image with stored authentication data (860). In some aspects, the authentication image may be the same as the image used for alignment purposes (e.g., the image of the user that is aligned with the selected positioning template). In other aspects, the authentication image may be captured by a different camera than the camera used for aligning the user with the selected positioning template. For example, a secondary camera (such as a 3D camera, infrared camera, or dedicated biometric camera) may capture the authentication image when the image alignment sub-module 224 determines that one or more features of user (such as the user's face and/or body position) is properly aligned with the selected positioning template (e.g., based on the image captured by the camera 212).

The authentication data may be based, at least in part, on reference images of one or more authorized users of the requested application and/or device (e.g., acquired during a training process). In some embodiments, the image comparison sub-module 226 may implement one or more facial recognition algorithms to identify similarities between the one or more features of the user (e.g., relative size and/or positioning of the user's eyes, nose, mouth, ears, etc.) and corresponding features of one or more authorized users (e.g., based on stored images of the authorized users). The image comparison sub-module 226 may allow access to the requested application and/or device only if a match is detected between the image of the user and the stored authentication data.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of camera-based authentication, comprising:
capturing a first image of a user during a first instance of camera-based authentication;
selecting a first positioning template from a plurality of positioning templates based at least in part on a security level associated with the first instance of camera-based authentication;
displaying the first image of the user concurrently with the first positioning template in a visual interface; and
capturing an authentication image when one or more features of the user are aligned with one or more visual cues of the first positioning template.

2. The method of claim 1, wherein each of the plurality of positioning templates is configured to be presented as a graphic overlay in the visual interface.

3. The method of claim 1, further comprising:
comparing the authentication image with stored authentication data.

4. The method of claim 3, wherein the one or more visual cues are generated based at least in part on the stored authentication data.

5. The method of claim 1, further comprising:
capturing a second image of the user during a second instance of camera-based authentication;
selecting a second positioning template from the plurality of positioning templates based at least in part on a security level associated with the second instance of camera-based authentication, wherein the security level associated with the second instance is lower than the security level associated with the first instance; and
displaying the second image of the user concurrently with the second positioning template in the visual interface.

6. The method of claim 5, wherein the second instance of camera-based authentication is part of a multi-modal authentication attempt, and wherein the multi-modal authentication attempt includes a greater number of authentication modes than an authentication attempt associated with the first instance of camera-based authentication.

7. The method of claim 5, wherein the second instance of camera-based authentication is part of a multi-factor authentication attempt, and wherein the multi-factor authentication attempt includes a greater number of authentication factors than an authentication attempt associated with the first instance of camera-based authentication.

8. The method of claim 5, wherein the first positioning template includes more visual cues than the second positioning template.

9. The method of claim 5, wherein the first positioning template corresponds with closer image capture distances than the second positioning template.

10. The method of claim 1, further comprising:
capturing a third image of the user during a third instance of camera-based authentication, wherein a security level associated with the third instance of camera-based authentication is lower than the security level associated with the first instance; and
displaying the third image of the user, without any of the positioning templates, in the visual interface.

11. An input device, comprising:
processing circuitry; and
memory storing instructions that, when executed by the processing circuitry, cause the input device to:
capture a first image of a user during a first instance of camera-based authentication;
select a first positioning template from a plurality of positioning templates based at least in part on a security level associated with the first instance of camera-based authentication;
display the first image of the user concurrently with the first positioning template in a visual interface; and
capture an authentication image when one or more features of the user are aligned with one or more visual cues of the first positioning template.

12. The input device of claim 11, wherein each of the plurality of positioning templates is configured to be presented as a graphic overlay in the visual interface.

13. The input device of claim 11, wherein execution of the instructions further causes the input device to:
compare the authentication image with stored authentication data.

14. The input device of claim 13, wherein the one or more visual cues are generated based at least in part on the stored authentication data.

15. The input device of claim 11, wherein execution of the instructions further causes the input device to:
capture a second image of the user during a second instance of camera-based authentication;
select a second positioning template from the plurality of positioning templates based at least in part on a security level associated with the second instance of camera-based authentication, wherein the security level associated with the second instance is lower than the security level associated with the first instance; and
display the second image of the user concurrently with the second positioning template in the visual interface.

16. The input device of claim 15, wherein the second instance of the camera-based authentication is part of a multi-modal authentication attempt, and wherein the multi-modal authentication attempt includes a greater number of authentication modes than an authentication attempt associated with the first instance of camera-based authentication.

17. The input device of claim 15, wherein the second instance of camera-based authentication is part of a multi-factor authentication attempt, and wherein the multi-factor authentication attempt includes a greater number of authentication factors than an authentication attempt associated with the first instance of camera-based authentication.

18. The input device of claim 15, wherein the first positioning template includes more visual cues, or corresponds with closer image capture distances, than the second positioning template.

19. The input device of claim 11, wherein execution of the instructions further causes the input device to:
capture a third image of the user during a third instance of camera-based authentication, wherein a security level associated with the third instance of camera-based authentication is lower than the security level associated with the first instance; and
display the third image of the user, without any of the positioning templates, in the visual interface.

20. A non-transitory computer-readable medium storing instructions that, when executed by processing circuitry of an input device, cause the input device to perform operations comprising:
capturing a first image of a user during a first instance of camera-based authentication;
selecting a first positioning template from a plurality of positioning templates based at least in part on a security level associated with the first instance of camera-based authentication;
displaying the first image of the user concurrently with the first positioning template in a visual interface; and
capturing an authentication image when one or more features of the user are aligned with one or more visual cues of the first positioning template.
